(19) United States
(12) Patent Application Publication
(10) Pub. No.: US 2005/0060354 A1
(43) Pub. Date: Mar. 17, 2005

(54) System and method of facilitating an icon selection among a plurality of icons on a desktop

(75) Inventors: Susann Marie Keohane, Austin, TX (US); Gerald Francis McBrearty, Austin, TX (US); Shawn Patrick Mullen, Buda, TX (US); Jessica Murillo, Hutto, TX (US); Johnny Meng-Han Shieh, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/660,027

(22) Filed: Sep. 11, 2003

(51) Int. Cl. G06F 17/30

(52) U.S. Cl. 707/200; 707/205

(57) ABSTRACT

A system and method of facilitating an icon selection among a plurality of icons on a desktop are provided. When a user desires to select an icon among a plurality of icons on a desktop, the user may assert an option that will prompt the user to enter a file extension. The file extension to be entered is preferably the file extension of the file that is represented by the icon to be selected. After entering or selecting the file extension, the file extensions of all the files that are represented by icons on the desktop are compared against the entered extension. All the icons that represent files with the same file extension as the one entered are grouped together and moved toward a pointing device. Once there, the user may easily select the proper icon.

### BACKGROUND OF THE INVENTION

1. Technical Field

The present invention is directed to electronic desktops. More specifically, the present invention is directed to a system and method of facilitating an icon selection from a plurality of icons on a desktop.

2. Description of Related Art

The most commonly used user interface paradigm for computing devices is the windows-icons-desktop-folders metaphor prevalent on computer systems such as the Macintosh or other computer systems running one of Microsoft Windows operating systems. Under this paradigm, the screen of a computer system simulates an office desktop that contains various objects. The objects are each represented by a graphical icon. Presently, there is no restriction on the number of icons that may be on a desktop. Thus in certain instances, a user may have a large number of icons on the desktop.

When a user decides to open a file, for example, using the icon displayed on the desktop that represents the file, the user has to first select the icon. This may be done using a pointing device, such as a mouse pointer for instance. In cases where there is a large number of icons on the desktop, the user may have difficulty selecting the icon in question from the rest of the icons on the desktop.

Thus, what is needed is a system and method of facilitating an icon selection among a plurality of icons on a desktop.

### SUMMARY OF THE INVENTION

The present invention provides a system and method of facilitating an icon selection among a plurality of icons on a desktop. When a user desires to select an icon among a plurality of icons on a desktop, the user may assert an option that will prompt the user to enter a file extension or choose from a pre-existing list of file extension types. The file extension to be entered is preferably the file extension of the file that is represented by the icon to be selected. After entering the file extension, the file extensions of all the files that are represented by icons on the desktop are compared against the entered extension. All the icons that represent files with the same file extension as the one entered are grouped together and moved toward a pointing device. Once there, the user may easily select the proper icon. In cases where there are folders on the desktop, the file extension of each file in the folder and/or the file extension of each file represented by an icon in the folder will be compared with the entered extension. If there is a match, the folder containing the file with the matched extension will moved toward the pointing device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 depicts a desktop with a plurality of icons displayed therein.

FIG. 5 illustrates a prior art graphical user interface (GUI) used to access options of a desktop.

FIG. 6 depicts a GUI used by the present invention.

FIG. 7 depicts a GUI for entering a file extension of an icon or group icons that are desired to be moved to the vicinity of a pointing device.

FIG. 8 depicts icons that are migrating toward a pointing device.

FIG. 9 depicts icons that have migrated toward a pointing device.

FIG. 10 depicts a GUI for entering a file extension of an icon or group icons on a plurality of desktops that are to be moved to the vicinity of a pointing device.

FIG. 11 is a flow diagram of a process used by the invention.

### DETAILED DESCRIPTION OF THE PREFERRED EMBODIMENT

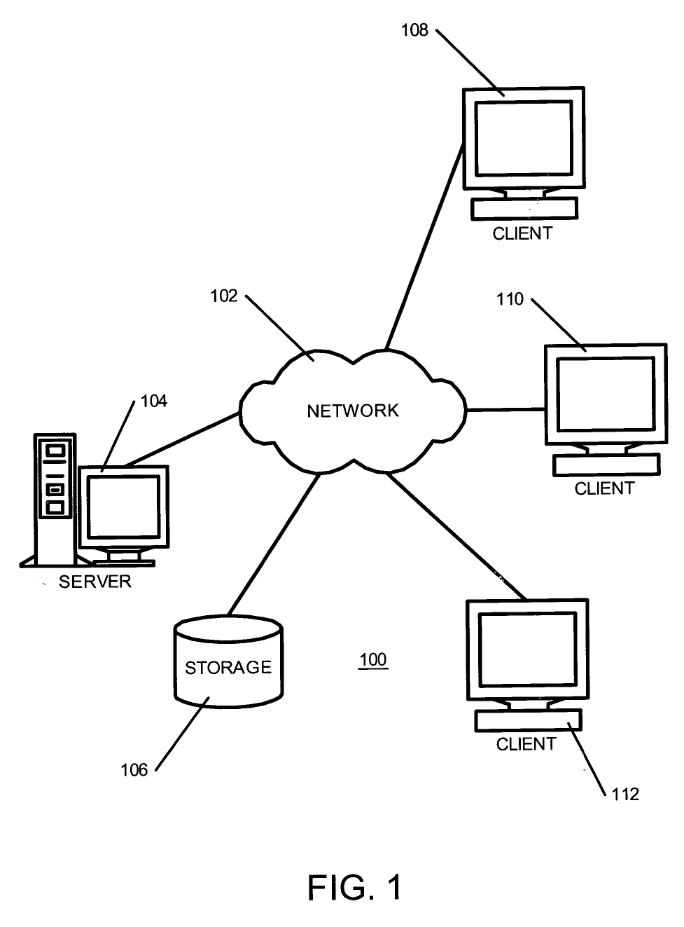

With reference now to the figures wherein like reference numerals refer to like parts, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

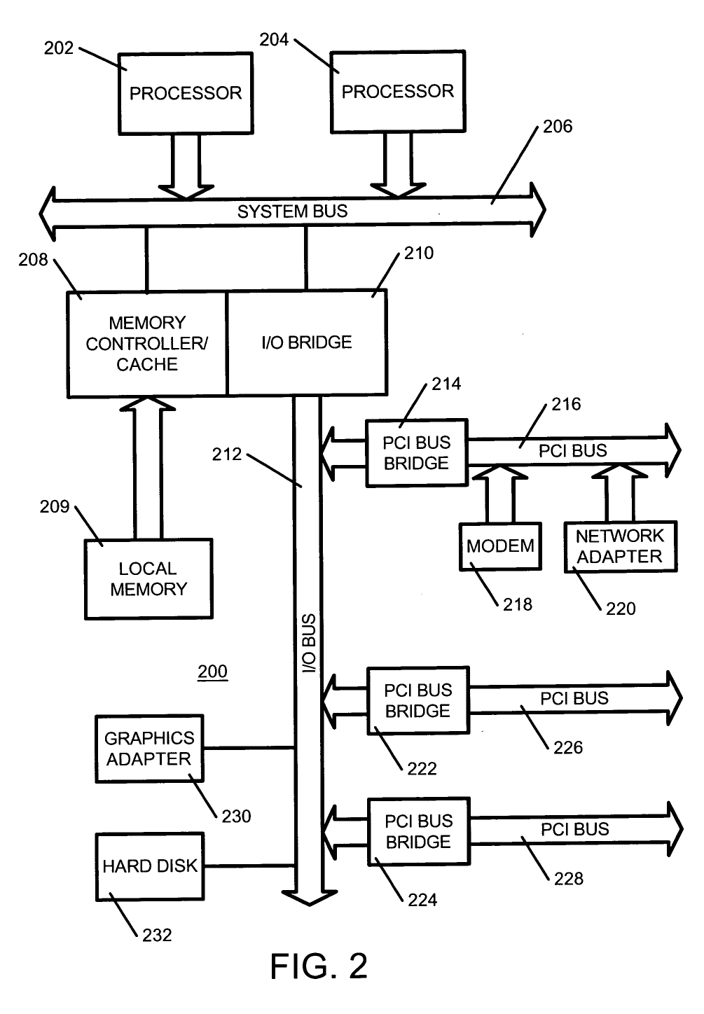

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

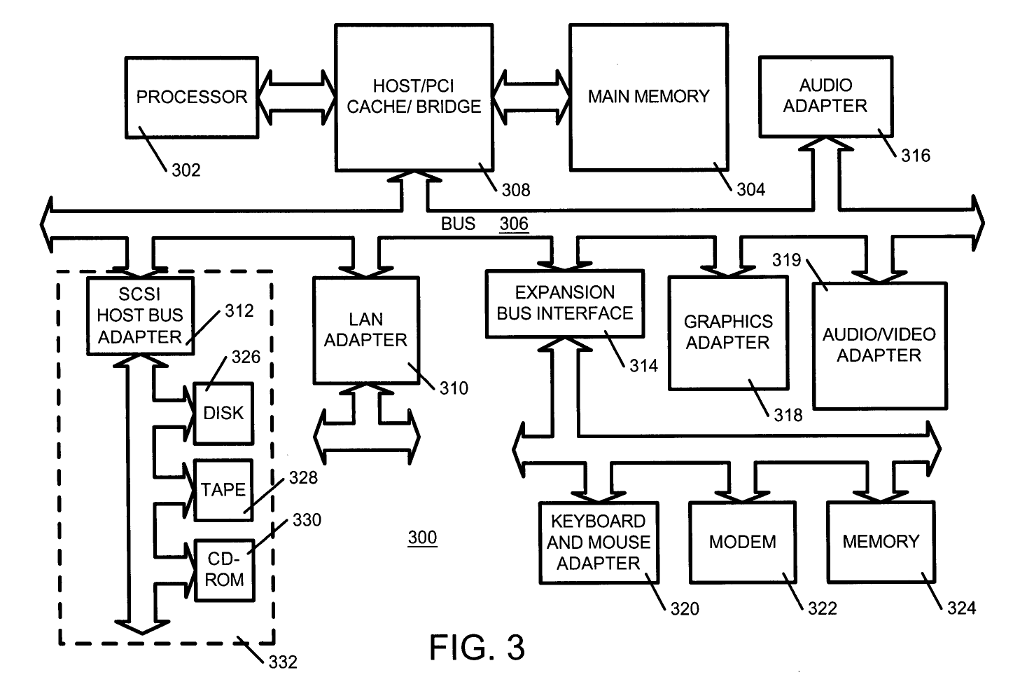

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows® XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of having an icon or group of icons on a desktop migrate toward a pointing device. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

The invention will be explained using Windows® XP. However, it should be understood that the invention will work equally as well with any other operating system. For example, the invention may be run on a common desktop environment (CDE). CDE is a graphical user interface that is available in most UNIX platforms as a standard window manager. Each time a user logs into a UNIX workstation, the CDE creates a desktop environment for the user to work in. Thus, Windows® XP is used for illustrative purposes only.

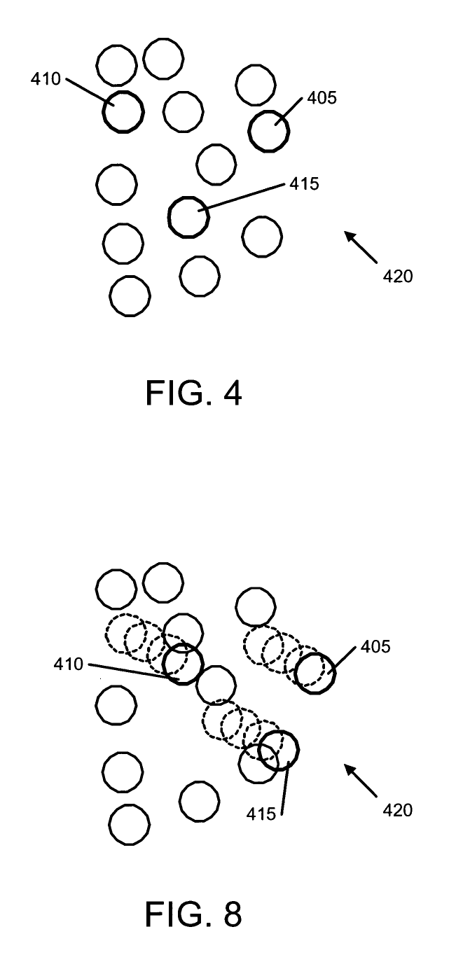

FIG. 4 depicts a plurality of icons on a desktop. In the figure, icons 405, 410 and 415 are displayed among a plurality of other icons. Further, mouse pointer 420 is also displayed in the figure. Icons 405, 410 and 415 represent files with similar file extension. For example, all three files may be “.gif” files or “.JPEG” files etc. In this particular example, icons 405, 410 and 415 represent files with the “.gif” file extension. In accordance with the invention, when a user desires to select one icon (e.g., icon 415) among a plurality of others on a desktop as shown in FIG. 4, the user needs to depress the right button of the mouse.

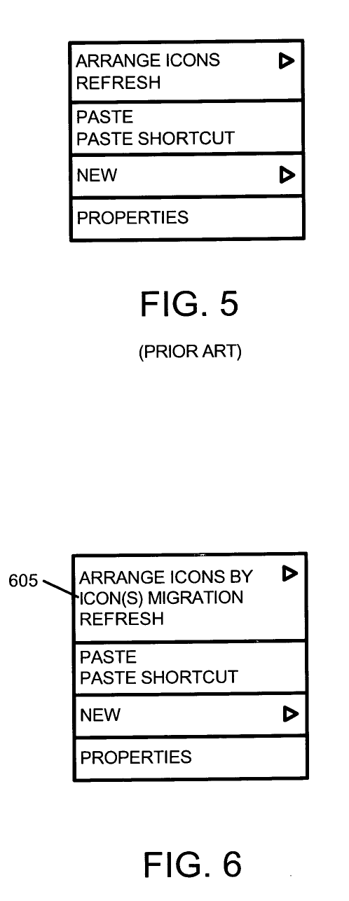

In Windows® XP, when the right button of the mouse is depressed while the desktop is displayed, FIG. 5 will pop open. The present invention adds a new option to FIG. 5. The new option, icon(s) migration option 605, is shown in FIG. 6. In FIG. 6, only the function of the new option icon(s) migration 605 is of importance to the invention; and thus, only the function of that option will be explained.

Before proceeding with the disclosure of the invention, some elementary graphical user interface (GUI) techniques need to be explained. In a nutshell, each displayed object has a set of X,Y coordinates that defines its location on the screen. When a button is clicked on a mouse, an interrupt (hardware signal) is sent by the mouse to the OS running on the computer system. Upon receiving the interrupt, the OS obtains the X,Y coordinates of the mouse pointer on the screen. The OS also figures out the mouse button that sent the interrupt (i.e. left, middle or right button). The X,Y coordinates of the pointer are then compared against X,Y coordinates of all options that are displayed on the screen. If there is a match with the X,Y coordinates of one of the displayed options then the function represented by that option is executed.

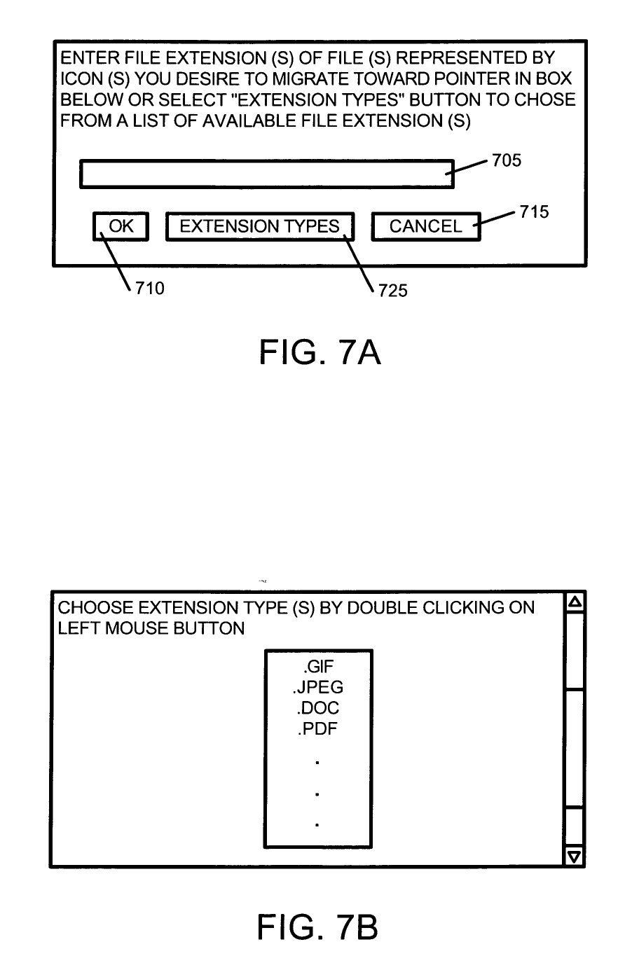

Returning to the figures, when the user asserts icon(s) migration option 605, FIG. 7a will pop open. In FIG. 7a, the user is prompted to enter in box 705 the file extension of the file that is represented by the icon that the user wishes to select. Alternatively, the user may assert button 725 to select from a list of available file extensions. If the user asserts button 725, FIG. 7b will pop open and the user may select from the list by double clicking on an item on the list. Each time the user double clicks on a file extension, the extension will automatically be entered in box 705 of FIG. 7a. This method of selecting items from a list is well known in the field and will not be explained.

The user is also instructed to assert OK button 710 when done. As customary, if the user decides against using the invention, the user may assert CANCEL button 715. To continue with the example above, if the user enters GIF for the “.gif” file extension in box 705, icons 405, 410 and 415 will migrate toward the pointer 420 since they all represent files with the “.gif” file extension. Specifically, when a user enters a file extension in box 705, it is compared with the extensions of all the files that are represented by an icon on the desktop. All the icons that represent files with the entered file extension will migrate toward the mouse pointer 420.

In the case, where folders are displayed on the desktop, the folders may also migrate toward the mouse pointer 420 if a file or an icon of a file contained therein has the same file extension as the extension entered by the user. The folders will also migrate toward the mouse pointer 420 if they contain a folder in which a file or an icon of a file with the same file extension as the one entered is stored therein. When a folder is opened, all items in the folder that have a file extension in common with the file extension entered by the user will again migrate toward the mouse pointer. This scenario will be repeated each time the invention is in use and a folder is opened.

When an icon and/or a folder is to migrate toward the mouse pointer, its on-screen X,Y coordinates are evaluated to determine where the icon and/or folder is in relation to the mouse pointer's on-screen X,Y coordinates. A straight line is then plotted from the X,Y coordinates of the icon and/or folder to just before those of the mouse pointer to ascertain that it is not displayed on top of the pointer 420. The icon and/or folder is then moved along the X,Y coordinates of the straight line. That is, periodically (e.g., after every half a second or so), the icon and/or folder may be drawn/redrawn at different (i.e., every ten to twenty) X,Y coordinates along the plotted straight line until it is drawn near the mouse pointer. When all the appropriate icons and/or folders are migrated toward the mouse pointer, a repelling algorithm may be used to ensure that the icons and/or folders are not placed one atop another. The repelling algorithm may place the icons and/or folders around the mouse pointer at an equal distance from each other.

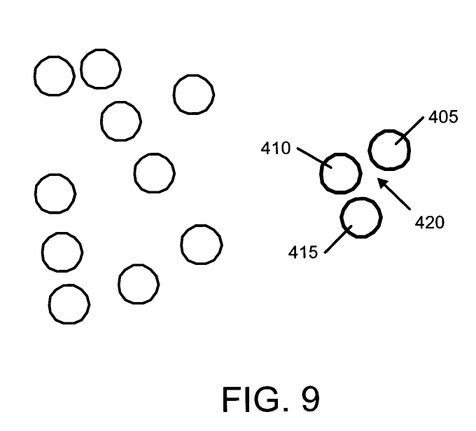

In FIG. 8, the icons 405, 410 and 415 are shown in migration toward mouse pointer 420 and in FIG. 9 they are shown to conglomerate around the pointer 420. Once the repelling algorithm places the icons in the vicinity of the pointer 420 as shown in FIG. 9, the icons may stop moving on the screen. This then enables a user to easily select one of the icons for use. In this example, the user may select icon 415.

Note that so long as the desktop is in the foreground, the icons will remain where they are located even if the mouse pointer is later moved from its original location. Particularly, if the user executes a file represented by an icon, the desktop will be displayed in the background. If the user redisplays the desktop in the foreground, the icons will be displayed in their initial or original location. To have the icons migrate again toward the mouse pointer 420, the invention will have to be re-executed.

Note also that in FIG. 7 more than one file extension may be entered in box 705 as long as they are separated by a comma, a space or some type of a separator. When more than one file extension is entered in box 705, icons representing files that have any one of the entered file extensions (as well as folders containing files with any one of the extensions) will migrate toward the pointing device 420.

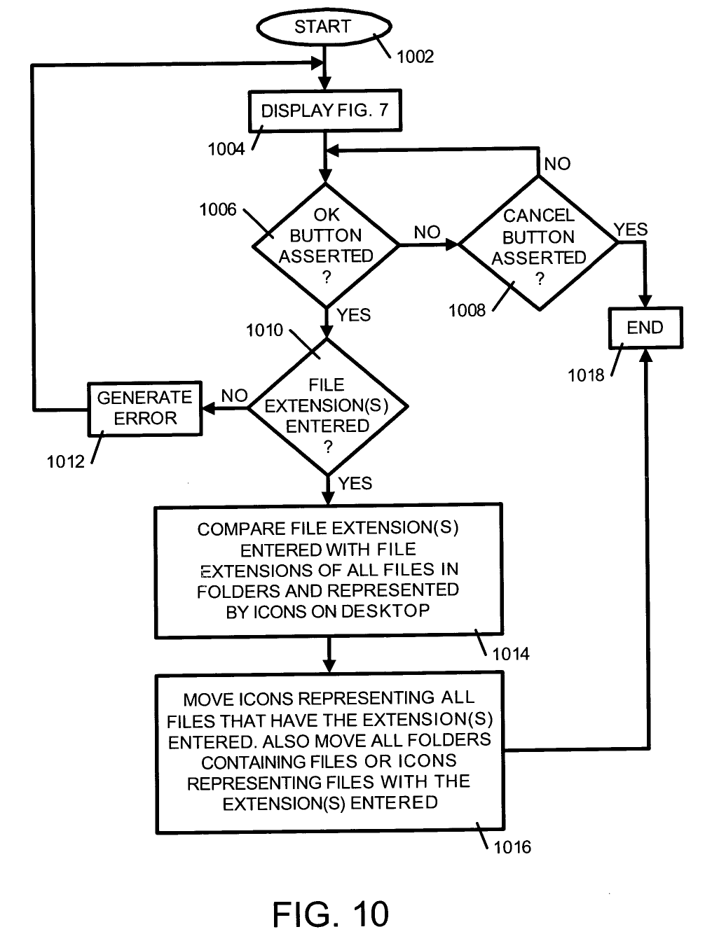

FIG. 10 is a flow chart of a process that may be used to implement the invention. The process starts when icon(s) migration option 605 is selected by displaying FIG. 7a (steps 1002 and 1004). Then a check is made to see whether the OK button 710 is asserted. If not, then a check is made to determine if the CANCEL button 715 is asserted. if CANCEL button 715 is not asserted, the process may return to step 1006 (steps 1006 and 1008). If the CANCEL button 715 is asserted, the process ends (steps 1008 and 1018).

If the OK button 710 is asserted, a check will be made to determine whether a file extension or extensions have been entered. If not, an error may be generated and the process may return to step 1004 after a certain amount of time has elapsed (steps 1006, 1010 and 1012). If a file extension or extensions have been entered, the invention will compare the file extension(s) entered with the file extension of each file represented by an icon on the desktop. The invention will also compare the file extension(s) entered with the file extension of files in the folders as well as files represented by icons in the folders. All icons representing files with the extension(s) entered and all folders containing files as well as icons representing files with the extension(s) entered will migrate toward the pointer before the process ends (steps 101, 1014, 1016 and 1018).

The description of the present invention has been presented for purposes of illustration and description, and is not intended to be exhaustive or limited to the invention in the form disclosed. Many modifications and variations will be apparent to those of ordinary skill in the art. For example, the invention may be used with application software such as drawing programs. Thus, the embodiment was chosen and described in order to best explain the principles of the invention, the practical application, and to enable others of ordinary skill in the art to understand the invention for various embodiments with various modifications as are suited to the particular use contemplated.

1. A method of facilitating an icon selection from a plurality of icons on a desktop comprising the steps of:
enabling a user to enter a file extension, the file extension being an extension of a file being represented by the icon to be selected;
comparing the entered file extension with file extensions of all files represented by an icon on the desktop; and
grouping all icons that represent files having the same file extension as the entered file extension at a location on the desktop.

2. The method of claim 1 wherein the location is a location close to a device with which the icon may be selected.

3. The method of claim 2 wherein the device is a pointing device.

4. The method of claim 3 wherein the pointing device is a mouse pointer.

5. The method of claim 1 wherein folders containing files and/or icons representing files with the entered extension are grouped at the location of the desktop.

6. The method of claim 5 wherein the location is a location close to a device with which the folders may be selected.

7. The method of claim 6 wherein the pointing device is a mouse pointer.

8. A computer program product on a computer readable medium for facilitating an icon selection from a plurality of icons on a desktop comprising:
code means for enabling a user to enter a file extension, the file extension being an extension of a file being represented by the icon to be selected;
code means for comparing the entered file extension with file extensions of all files represented by an icon on the desktop; and
code means for grouping all icons that represent files having the same file extension as the entered file extension at a location on the desktop.

9. The computer program product of claim 8 wherein the location is a location close to a device with which the icon may be selected.

10. The computer program product of claim 9 wherein the device is a pointing device.

11. The computer program product of claim 11 wherein the pointing device is a mouse pointer.

12. The computer program product of claim 8 wherein folders containing files and/or icons representing files with the entered extension are grouped at the location of the desktop.

13. The computer program product of claim 12 wherein the location is a location close to a device with which the folders may be selected.

14. The computer program product of claim 13 wherein the pointing device is a mouse pointer.

15. A system for facilitating an icon selection from a plurality of icons on a desktop comprising:
at least one storage device for storing code data; and
at least one processor for processing the code data to enable a user to enter a file extension, the file extension being an extension of a file being represented by the icon to be selected, to compare the entered file extension with file extensions of all files represented by an icon on the desktop, and to group all icons that represent files having the same file extension as the entered file extension at a location on the desktop.

16. The system of claim 15 wherein the location is a location close to a device with which the icon may be selected.

17. The system of claim 16 wherein the device is a pointing device.

18. The system of claim 17 wherein the pointing device is a mouse pointer.

19. The system of claim 15 wherein folders containing files and/or icons representing files with the entered extension are grouped at the location of the desktop.

20. The system of claim 19 wherein the location is a location close to a device with which the folders may be selected.
